(19) United States
(12) Patent Application Publication
(10) Pub. No.: US 2022/0117828 A1
(43) Pub. Date: Apr. 21, 2022

(54) SMART WALKING FOOT ASSEMBLY WITH DYNAMIC FEEDBACK

(71) Applicant: Ethicon, Inc., Somerville, NJ (US)

(72) Inventors: Rajitha Aluru, Houston, TX (US); William Cohn, Houston, TX (US); Megan Greenwood, Houston, TX (US); Matthew Kuhn, Houston, TX (US); Yufei Cui, Houston, TX (US); Shade V. Flavien, Baytown, TX (US); Katherine C. Hu, San Jose, CA (US); Shujian Lin, Houston, TX (US); Adalberto F. Machin, Miami, FL (US); Mykia M. Washington, Tewksbury, MA (US)

(21) Appl. No.: 17/450,450

(22) Filed: Oct. 8, 2021

Related U.S. Application Data
(60) Provisional application No. 63/092,201, filed on Oct. 15, 2020.
(60) Provisional application No. 63/180,813, filed on Apr. 28, 2021.

(51) Int. Cl. A61H 3/02; A45B 9/04

(52) U.S. Cl. CPC A61H 3/0288; A45B 9/04; A61H 2201/5061; A45B 2009/005; A61H 2201/5007; A61H 2201/5043; A61H 2201/5084; A61H 2201/5048

(57) ABSTRACT

Smart walking devices, assemblies, and methods of using the same. Improved partial weight bearing requirements while using a walking aid may be provided. An example smart foot assembly may include a tubular sheath with a spring assembly connected to a foot with a force sensor coupled to the spring assembly wherein during a load phase as the distal end of the foot contacts the ground, the foot moves proximally as load is increased.

### CROSS-REFERENCE TO RELATED APPLICATIONS

This application claims priority to and the benefit of U.S. Provisional Patent Application No. 63/092,201 titled “SMART WALKING FOOT ASSEMBLY WITH DYNAMIC FEEDBACK,” filed on Oct. 15, 2020 and U.S. Provisional Patent Application No. 63/180,813, titled “SMART WALKING FOOT ASSEMBLY WITH DYNAMIC FEEDBACK,” filed on Apr. 28, 2021, the entirety of both of which are hereby incorporated by reference herein.

### BACKGROUND

### 1. Field

The present disclosure relates to walking aids, and more particularly, to systems and methods for relaying partial weight bearing requirements of a user of walking aids.

### 2. Description of the Related Art

Crutches are estimated to be used by over 7 million people annually and are one of the most often prescribed orthotic aids. Canes and crutches, as well as other assistive walking devices, can be used for long-term stability and mobility enhancement or may be used temporarily during the rehabilitation phase of a lower extremity injury, such as a bone fracture. Rehabilitation programs vary greatly but all have the goal of taking the patient from a state of limited weight bearing on the injured limb through to full weight bearing, and many programs will progress through various phases of increasing partial weight bearing during the healing process. Bearing too much weight too soon can cause further injury. Bearing too little weight can compromise healing since muscles need to be rebuilt and mechanical stress is needed to stimulate bone growth.

As partial weight bearing requirements are defined and communicated to the patient, methods for correctly training the patient are limited. The current method employed is usually one of the following: (1) telling the patient to use their best judgement to achieve the target weight bearing; or (2) having the patient stand on a scale to achieve the correct weight balance in the hope that they can remember how it feels and replicate the loading later in their daily walking. Neither of these methods results in a consistent or verifiable result as the patient goes about his/her daily life. In cases of poor healing (including non-union), clinicians are not provided with any data on the patient's compliance to the rehabilitation program which makes it difficult to inform a diagnosis or correction plan. Additionally, making connections between the healing performance of many patients becomes impossible due to lack of data for comparison and trend-finding. This is evident in the varied approach to fracture rehabilitation employed by different clinicians. Last, it can be frustrating for patients to work through their healing process unguided and blind to the progress being made. Patient motivation and satisfaction can be improved by making their progress toward a goal more easily understood.

Accordingly, there exists a need for an apparatus and method for relaying to a user partial weight bearing requirements.

### SUMMARY

The present disclosure relates to smart walking devices, assemblies, and methods of using the same. An example smart foot assembly may include a spring sheath having a bore with a proximal end and a distal end. The bore may hold a support rod having a threaded section that mates with a threaded slide including at least one protrusion. A swivel cap may be coupled to the support rod allowing the support rod to rotate. A spring assembly may be housed in the spring sheath. The spring sheath may have at least one slide slot that mates with the at least one protrusion of the threaded slide. The spring assembly may include a spring coupled to a spring piston.

The smart foot assembly may include a foot coupled to the distal end of the spring sheath and having a distal end configured to engage a surface. A force sensor may be coupled to the spring piston and the foot. The spring piston may be configured to push up against the spring when a preload force is surpassed so that the foot moves proximally as load is increased as the distal end of the foot contacts the surface during a load phase.

The spring sheath may be configured to fit inside the bore of a lower tubular section of a walking aid. The foot may be capable of coupling to a distal end of the lower tubular section of the walking aid. A friction fitting may be configured to couple to the lower tubular section of the walking aid such that when the user holds the friction fitting while rotating the foot, the friction fitting maintains an outer sheath with respect to the support rod, allowing the support rod to rotate.

A spring sheath cap may be coupled to the proximal end of the spring sheath.

The support rod may have a horizontal slide rod located toward a distal end of the support rod and the foot may include an outer slide slot. The horizontal slide rod may be slidably engaged with the outer slide slot to allow a user to rotate the support rod upon rotation of the foot.

During a no-load phase, a preload force in an adjustable spring may cause the foot assembly to slide distally until the horizontal slide rod contacts an upper end of the inner slide slot.

During the load phase, as the distal end of the foot assembly contacts the surface, the foot may slide proximally until the horizontal slide rod contacts a lower end of the inner slide slot.

The inner slide slot may have a feedback mechanism located proximal to an upper end of the inner slide slot for providing feedback as the horizontal rod is arrested by the feedback mechanism.

The smart foot assembly may further include an inner slide slot in the spring piston. The horizontal slide rod may be slidably engaged with both the slide slot in the housing and the inner slide slot.

The spring of the smart foot assembly may be non-linear, and may have sections with different spring rates. It may be one integral spring or include multiple linear springs stacked on top of another.

The foot may be configured to slide between 0.1 and 1.1 inches.

The smart foot assembly may also have a vibration module in the handle configured to activate when the force sensor reaches a predetermined level. The smart foot assembly may have an alarm which provides auditory feedback when the force sensor reaches a predetermined level.

A microprocessor may be configured to exchange data via a wired connection to an electronic device.

The foot may include a housing configured to house a battery, a microprocessor, and a wireless transceiver configured to transfer electronic data to an electronic device. The electronic device may display at least one of the following: load through walking approximated load through injury, step counts, step frequency, duration of exercise, balance/consistency, user-entered pain metrics, user-entered exercises/stretches, or physician evaluation metrics. The electronic device may display measurements obtained from a force sensor.

A motor may be coupled to the support rod such that when a user inputs a target force into a mobile application, a signal is sent to the microprocessor to turn on the motor until the desired pre-load force is established.

Inertial measurement unit data from a mobile device may be incorporated into data selected from the group consisting of gait phase event data, fall prediction, and fall detection.

Data from sensors located in proximity to a user's foot or the distal end of the smart foot assembly may be incorporated into gait phase event data. The sensors may include at least one of an accelerometer, gyroscope, magnetometer, or an inertial measurement unit. The sensors located in proximity to a user's foot may be at least one of LIDAR, ultrasound, magnetic hall effect, camera with video processing, or microphones.

Another example of a smart foot assembly includes a friction fitting having a proximal end and a distal end. The proximal end of the friction fitting may be capable of being coupled with a lower tubular section of a walking aid. A force sensor may be coupled to the friction fitting and may have a distal end. A foot may be coupled to the distal end of the force sensor. The foot may be configured to engage a surface.

The foot may have a non-slip surface at the distal end of the foot for engaging a surface.

Another example of a smart walking device includes a tip having a force sensor, a hand grip having a housing located in proximity to the hand grip, the housing containing an orientation sensor and a microcontroller that is configured to record and analyze measurements obtained from the force sensor and the orientation sensor. A shaft may connect the hand grip and the tip.

An interface may be coupled to the microcontroller in order to inform the user of the smart walking device of the measurements obtained from the force sensor and the orientation sensor.

A method for setting a preload force on a smart foot assembly is also disclosed herein, the method may include utilizing a smart foot assembly including a spring sheath having a bore with a proximal end and a distal end. The bore may house a spring assembly therein. The spring assembly may have a spring coupled to a support rod having a distal end and a threaded section that mates with a threaded slide having at least one protrusion that mates with a slide slot along the proximal end of a spring sheath.

The spring assembly may have a foot having a distal end configured to engage a surface and a housing containing a force sensor coupled to a spring piston which may be concentrically arranged with respect to the distal end of the support rod.

The method may include rotating the support rod in the spring assembly by rotating the foot with respect to the spring sheath such that the threaded slide stays oriented with the slide slot causing the threaded slide to travel vertically along the threaded portion of the support rod. The vertical travel along the support rod may increase or decrease preload force on the spring.

A method of providing percentage body weight information to a user of a smart foot assembly. The method may include utilizing a smart foot assembly including a spring sheath having a bore with a proximal end and a distal end. The smart foot assembly may include a foot having a non-slip surface at the distal end of the foot for engaging a surface, and at least one sensor for gathering gait phase event data and measured device force located in the foot, the spring sheath, or in proximity to a user's foot.

The method may include taking the gait phase event data and the measured device force and translating into an estimated force through the user's leg.

A method for providing ground reaction forces on a leg of a user of at least one smart walking device is also disclosed herein, the method including utilizing the at least one smart walking device including a tip having a force sensor, a hand grip having a housing located in proximity to the hand grip, the housing containing an orientation sensor and a microcontroller that is configured to record and analyze measurements obtained from the force sensor and the orientation sensor. A shaft may connect the hand grip and the tip.

The method may include utilizing a generalized M curve for the ground reaction forces on an entire body of the user and subtracting the forces measured by the at least one smart walking device. The forces may be subtracted from the ground reaction forces.

### BRIEF DESCRIPTION OF THE DRAWINGS

These and other features, aspects, and advantages are described below with reference to the drawings, which are intended to illustrate, but not to limit, the disclosure. In the drawings, like reference characters denote corresponding features consistently throughout similar embodiments.

FIG. 1A illustrates a perspective view of a smart foot assembly according to an aspect of the present disclosure.

FIG. 1B illustrates a perspective view of the smart foot assembly of FIG. 1A attached to a walking aid according to an aspect of the present disclosure.

FIG. 1C illustrates a cross-section view of the smart foot assembly of FIG. 1A according to an aspect of the present disclosure.

FIG. 2 illustrates a sectional view of a lower tubular sheath and a foot of the smart foot assembly of FIG. 1A according to an aspect of the present disclosure.

FIG. 3A illustrates a sectional view of the smart foot assembly of FIG. 1A when no load is applied according to an aspect of the present disclosure.

FIG. 3B illustrates a sectional view of the smart foot assembly of FIG. 1A when full load is applied according to an aspect of the present disclosure.

FIG. 4A illustrates a sectional view of a foot of a smart foot assembly of having a load cell according to an aspect of the present disclosure.

FIG. 4B illustrates a sectional view of a spring piston assembly of a smart foot assembly according to an aspect of the present disclosure.

FIG. 4C illustrates a sectional view of a connection of the foot of FIG. 4A and the spring piston assembly of FIG. 4B according to an aspect of the present disclosure.

FIG. 4D illustrates a sectional view of a welded connection of a foot and a spring piston assembly of a smart foot assembly according to an aspect of the present disclosure.

FIG. 5A illustrates a side sectional view of a dynamic feedback mechanism of the smart foot assembly of FIG. 1A under a small preload according to an aspect of the present disclosure.

FIG. 5B illustrates a front sectional view of the dynamic feedback mechanism of the smart foot assembly of FIG. 1A under a large preload according to an aspect of the present disclosure.

FIG. 6A illustrates a sectional view of a progressive rate spring of the smart foot assembly of FIG. 1A according to an aspect of the present disclosure.

FIG. 6B illustrates a sectional view of a deflection of the foot of the smart foot assembly of FIG. 1A according to an aspect of the present disclosure.

FIG. 7A illustrates a graph showing limb and device contact angles and forces according to an aspect of the present disclosure.

FIG. 7B illustrates a graph showing gait characteristics and forces according to an aspect of the present disclosure.

FIG. 8 illustrates a sectional view of a spring feedback mechanism of the smart foot assembly of FIG. 1A according to an aspect of the present disclosure.

FIG. 9A illustrates a perspective view of a vibration module of the smart foot assembly of FIG. 1B according to an aspect of the present disclosure.

FIG. 9B illustrates a detailed view of the vibration module of FIG. 9A according to an aspect of the present disclosure.

FIG. 10A illustrates a cross-section view of a smart foot assembly without a spring assembly according to an aspect of the present disclosure.

FIG. 10B illustrates a cross-section view of a smart foot assembly including a motor according to an aspect of the present disclosure.

FIG. 11 illustrates a schematic drawing of a hardware assembly and a housing of a smart foot assembly according to an aspect of the present disclosure.

FIG. 12 illustrates a perspective view of a walking aid modified into a smart foot assembly according to an aspect of the present disclosure.

FIG. 13 illustrates a perspective view of a force sensor of a smart foot assembly according to an aspect of the present disclosure.

FIG. 14 illustrates a schematic drawing of directions of angles measured in an orientation sensor of a smart foot assembly according to an aspect of the present disclosure.

FIG. 15 illustrates a schematic drawing of a connection of a Berry IMU to a Raspberry Pi via an I2C interface according to an aspect of the present disclosure.

FIG. 16 illustrates a perspective view of the housing of FIG. 11 according to an aspect of the present disclosure.

FIG. 17 illustrates a perspective view of a component of the housing of FIG. 11 according to an aspect of the present disclosure.

FIG. 18 illustrates a schematic drawing showing flow of power from a microcontroller through a GPIO out pin according to an aspect of the present disclosure.

FIG. 19 illustrates a flow chart of a biofeedback generation script according to an aspect of the present disclosure.

FIG. 20A illustrates a homepage of a user interface of a mobile application according to an aspect of the present disclosure.

FIG. 20B illustrates a daily reports page of the user interface of the mobile application of FIG. 20A according to an aspect of the present disclosure.

FIG. 20C illustrates a long-term data page of the user interface of the mobile application of FIG. 20A according to an aspect of the present disclosure.

FIG. 20D illustrates a settings page of the user interface of the mobile application of FIG. 20A according to an aspect of the present disclosure.

FIG. 21 illustrates a flowchart for displaying information using uses back-end data processing strategies to transmit, organize and store collected data according to an aspect of the present disclosure.

FIG. 22 illustrates a graph showing a gait cycle or an “M Curve” according to an aspect of the present disclosure.

FIG. 23 illustrates a graph of a calculated injured leg force from walking device forces according to an aspect of the present disclosure.

FIG. 24 illustrates a flow chart for estimating ground reaction forces on an injured leg according to an aspect of the present disclosure.

### DETAILED DESCRIPTION

The present disclosure provides improved assemblies, devices, and methods for relaying partial weight bearing requirements to a user. An exemplary device is a smart foot assembly 100 which may be integrated into an existing walking aid 102 such as a standard cane or crutch.

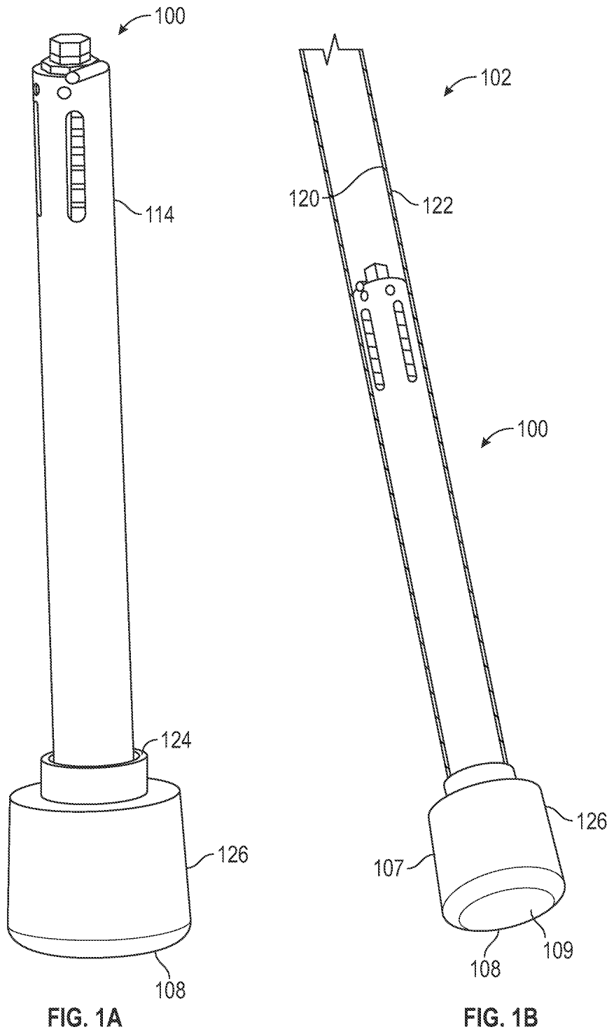

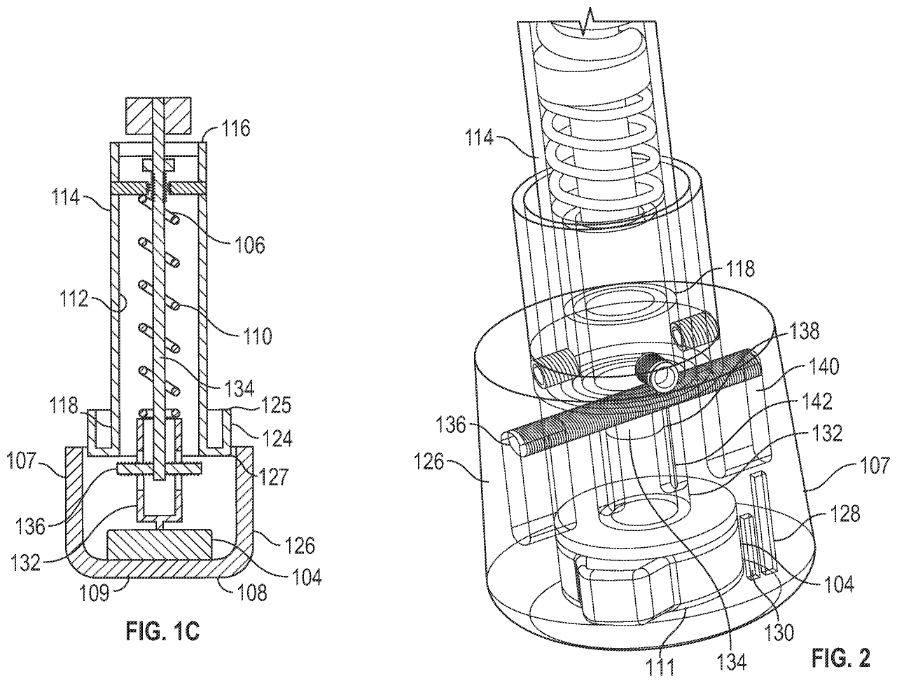

Referring to FIGS. 1A-1C, a rubber foot of an existing walking aid 102 may be removed and replaced with the smart foot assembly 100, which may be comprised of sensors 104 (e.g., a force sensor, an orientation sensor), a spring 106 that may be an adjustable spring, and a non-slip surface 108 for interaction with a ground surface. A spring assembly 110 may be housed within a bore 112 of a spring sheath 114, which has a proximal end 116 and a distal end 118. The spring assembly 110 may include a spring 106 coupled to a spring piston 132. The spring 106 may be coupled to a support rod 134. The spring sheath 114 may be configured (e.g., sized) to fit inside a bore 120 of a lower tubular section 122 of an existing walking aid 102. The electronic components, as described in greater detail below, may be located in the housing 126 of a foot 107 which is located immediately below the distal end 118 of the spring sheath 114. The foot 107 may be coupled to the distal end 118 of the spring sheath 114 and may have a distal end 109 configured to engage a surface, such as the ground. The distal end 109 may include the non-slip surface 108. As the distal end 118 of the spring sheath 114 is slid into the lower tubular section 122 of the walking aid 102, a friction fitting 124 may slide over the outer diameter of the lower tubular section 122 of the walking aid 102 to secure the foot 107 onto the walking aid 102. The friction fitting 124 may have a proximal end 125 and a distal end 127, with the proximal end 125 configured to couple to the lower tubular section 122 of the walking aid 102. A force sensor may be coupled to the friction fitting 124.

It is also envisioned that the smart foot assembly 100 may be preassembled into a walking aid 102. In such a case, the spring assembly 110 would reside directly in the lower tubular section 122 of the walking aid 102 with the friction fitting 124 coupled to the lower tubular section 122. In either the modular device or the preassembled device, a user may use the friction fitting 124 as a grip and then rotate the foot 107, thus allowing for adjustment of the adjustable spring 106 as described in further detail below.

Referring now to FIG. 2, the sensor 104, which may include a force sensor, may measure compression loads through the foot 107. The sensor 104 may be compact enough to fit within foot housing 126 having a 1.5 inch diameter. The sensor 104 may have a range of at least 10 to 200 lbf with an accuracy better than +/−2 lbf. For example, the sensor 104 may be the FX1901-0001-0200-L load cell by Measurement Specialties.

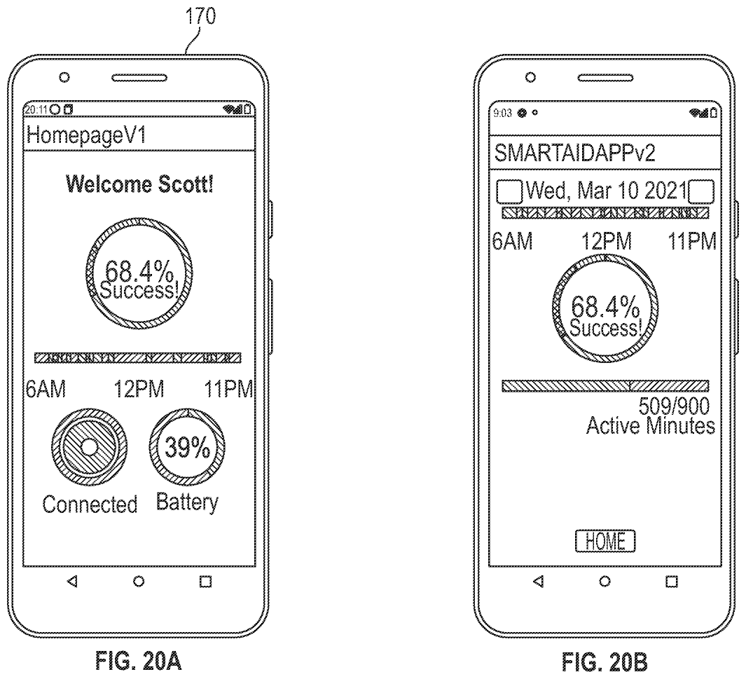

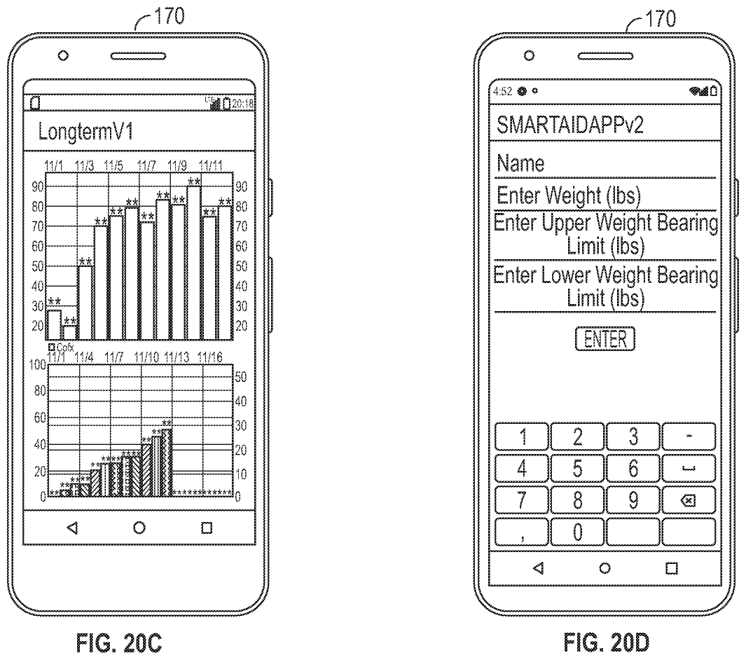

A microprocessor 128 may also be located in the foot housing 126 and may include Bluetooth capabilities to communicate with a nearby electronic device, such as the user's mobile phone. A wireless transceiver (such as Bluetooth or another form or wireless transmission) may be utilized to transfer electronic data to an electronic device. To improve simplicity of electronics and reduce battery usage, wired connections may be used instead of Bluetooth. The microprocessor 128 may be configured to exchange data via a wired connection to an electronic device. The wires may be routed inside or secured along the exterior of the walking aid 102 to a convenient point to connect a mobile device 170 (as shown in FIG. 20A for example) or other electronics.

The microprocessor 128 and other electronics may be powered by a compact battery 130 located within the foot housing 126. The battery 130 may be accessible to the user for replacement or may be charged via a power cord and/or via wireless power transmission. The energy usage of the smart foot assembly 100 and the size of the battery 130 may be sufficient for the extent of the injury rehabilitation, i.e. several months. The housing 126 of the foot 107 may be configured to house the battery 130, the microprocessor 128, and a wireless transceiver.

The microprocessor 128 and the battery 130 may be located in the foot housing 126 radially about the sensors 104, axially above or below the sensors 104 (with durable compartments to shield them from the axial loads), or a combination of the two locations. Some or all of the electronic components may also be located within the spring sheath 114. The smart foot assembly 100 may additionally include means for utilizing the cyclical compression of a spring piston 132 (resulting from the walking movement of the user) to recharge the integrated battery 130. A means for recharging the integrated battery 130 may include the linear movement of the spring piston 132 at least partially comprising a magnetic element (not shown) within the foot housing 126 at least partially comprising a coil (not shown).

Still referring to FIG. 2, the sensors 104 may be coupled to the spring piston 132 and the foot 107. The force sensor may have a distal end 111, with the foot 107 coupled to the distal end 111 of the force sensor. A support rod 134 is held in the bore 112 of the spring sheath 114 with a distal end 138 that leads into the spring piston 132. The spring piston 132 may be concentrically arranged with respect to the distal end 138 of the support rod 134. The support rod 134 may have a horizontal slide rod 136 located toward the distal end 138 of the support rod 134. The housing 126 of the foot 107 may have an outer slide slot 140. The horizontal slide rod 136 may then be slidably engaged with the outer slide slot 140 to allow a user to rotate the support rod 134 upon rotation of the foot 107. The foot 107 may also have an inner slide slot 142 in the spring piston 132, wherein the horizontal slide rod 136 is slidingly engaged with both the outer slide slot 140 in the foot housing 126 and an inner slide slot 142.

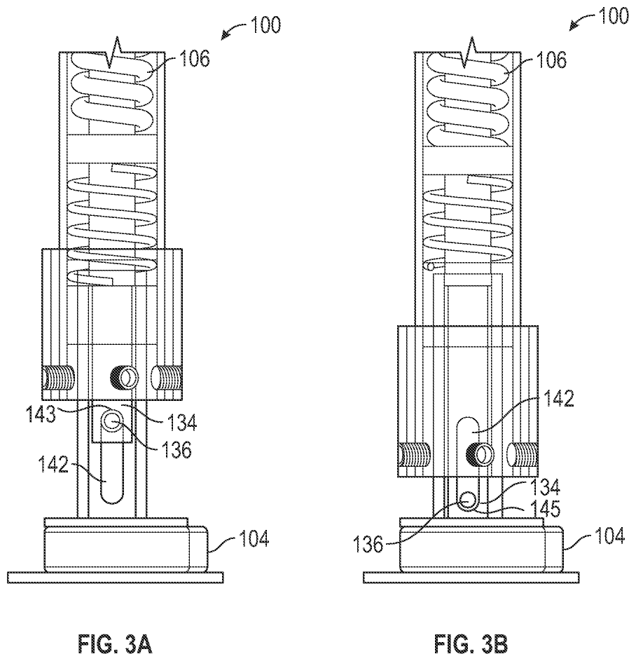

FIGS. 3A and 3B illustrate the smart foot assembly 100 configuration throughout different phases of the gait cycle. When a user is supported in a single leg stance on their non-injured leg, the user may advance the walking aid 102 (see FIG. 1B) forward through the air and therefore no body weight or other compressive force may be acting on the smart foot assembly 100 or the walking aid 102. During this no-load phase, gravity pulls the attached smart foot assembly 100 downward. This gravity force is counteracted by the friction fitting 124 (see FIGS. 1A-1C) of the smart foot assembly 100 on the lower tubular section 122 (see FIG. 1B) of the walking aid 102. The other force acting on the smart foot assembly 100 may be that of the preload in the adjustable spring 106. This force reacts through the sensors 104 including the force sensor in the housing 126 of the foot 107 (see FIG. 2), pushing the foot 107 to slide distally along the horizontal slide rod 136 until the horizontal slide rod 136 hits the upper stop 143 of the inner slide slot 142. During the no-load phase the preload force in the spring 106 may cause the foot 107 to slide distally until the horizontal slide rod 136 hits an upper end of the inner slide slot 142.

During the load phase, as the non-slip surface 108 (see FIGS. 1A-1C) of the smart foot assembly 100 contacts a ground surface, the foot 107 slides proximally until the horizontal slide rod 136 contacts a lower end 145 of the inner slide slot 142. The spring piston 132 may be configured to push up against the spring 106 when the preload force is surpassed so that the foot 107 moves proximally as load is increased as the distal end 109 of the foot 107 contacts a surface (such as the ground) during the load phase. The foot 107 may slide between 0.1 and 1.1 inches, or preferably between 0.4 and 0.8 inches.

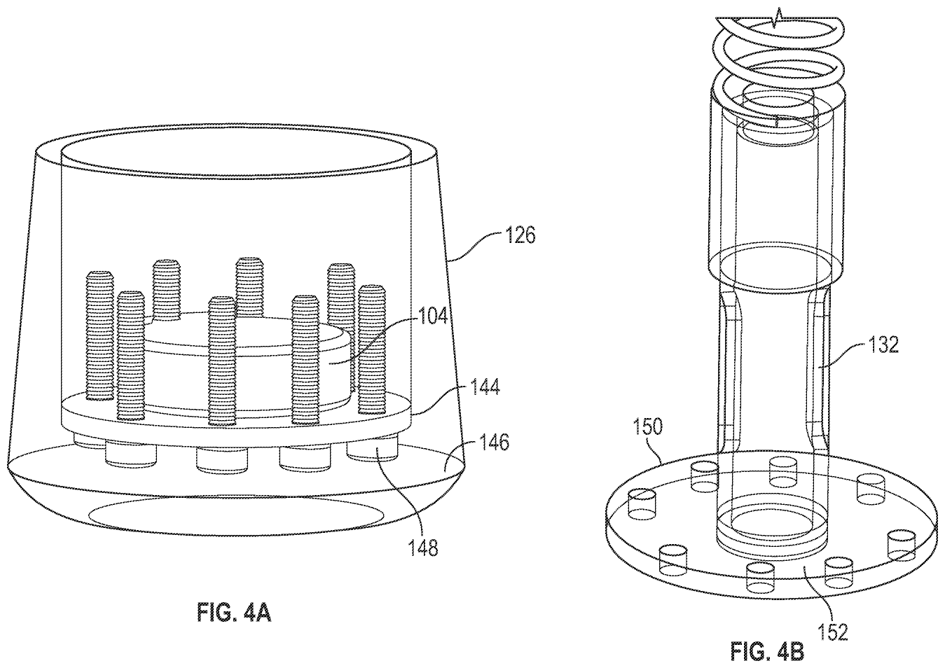

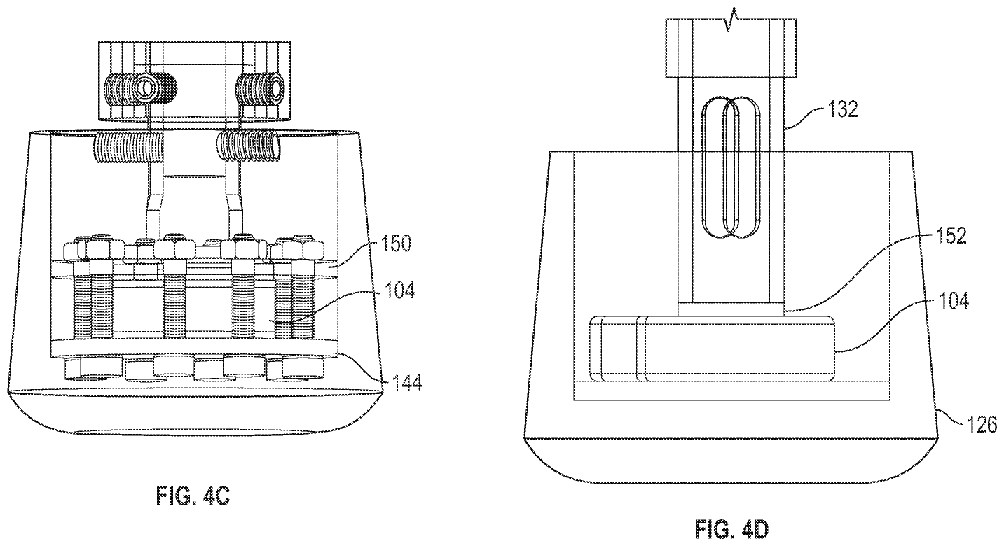

Referring now to FIGS. 4A-4D, multiple configurations for the spring piston 132 and the foot housing 126 are contemplated herein. FIG. 4A shows a plate 144 coupled to the bottom floor 146 of the foot housing 126. The plate 144 may have a plurality of bolts 148 therethrough and the sensors 104 coupled to plate 144. FIG. 4B shows another plate 150 coupled to a distal end 152 of the spring piston 132. The plate 150 may be coupled to the plate 144 via screws with the sensors 104 therebetween as shown in FIG. 4C. These components may be rigidly connected and may move axially with compression/extension of the spring 106. During the no-load phase, the distal end 152 of the spring piston 132 may contact the sensors 104 with negligible force. As the spring force or ground force increases, the entire load may travel through the sensors 104. FIG. 4D shows another embodiment where the distal end 152 of the spring piston 132 is coupled to the sensors 104, and the sensors 104 are coupled to the foot housing 126. This coupling may be accomplished via welding or using glue or another adherent.

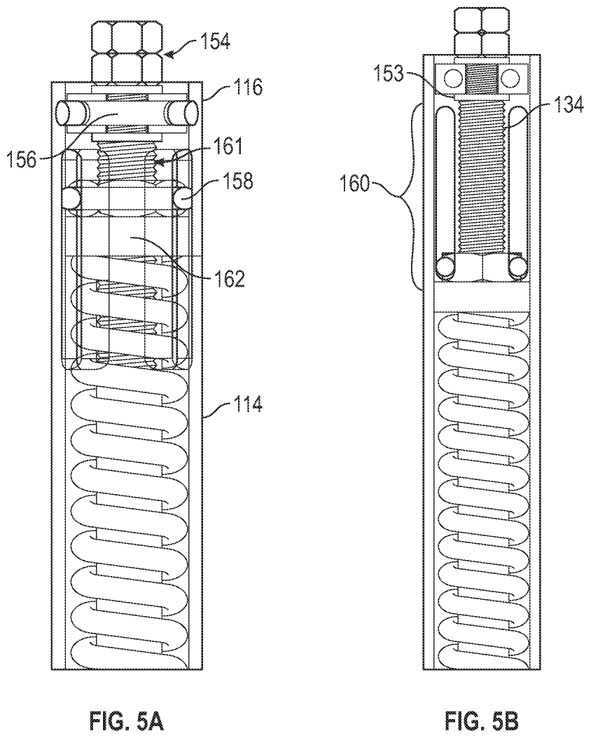

Referring now to FIGS. 5A and 5B, a proximal end 153 of the support rod 134 may be held in place by a swivel cap 154 which allows the support rod 134 to swivel about a spring sheath cap 156. The swivel cap 154 may be coupled to the support rod 134 allowing the support rod 134 to rotate. The spring sheath cap 156 may be rigidly coupled to the proximal end 116 of the spring sheath 114. The support rod 134 may have a threaded section 161 that mates with a threaded slide 158. The threaded slide 158 may have at least one protrusion that mates with slide slots 160 along the proximal end 116 of the spring sheath 114. The spring sheath 114 may have at least one slide slot 160 that mates with the at least one protrusion of the threaded slide 158. As the support rod 134 is rotated, the threaded slide 158 may be forced to stay oriented with the slide slots 160 and travel vertically along the threaded portion of the support rod 134. This vertical travel may be the mechanism for increasing or decreasing the spring 106 preload. An optional spring spacer 162 may be located distal to the threaded slide 158.

Referring back to FIGS. 1A-1C, the rotation of the support rod 134 may be done by manual rotation of the housing 126 of the foot 107. The user may place one hand on the outer diameter of the foot 107; the other hand may be placed on the outer diameter of the friction fitting 124 or elsewhere on the lower tubular section 122 or other component of the walking aid 102. The foot 107 may then be rotated while keeping the walking aid 102 (along with connected friction fitting 124 and spring sheath 114) stationary. The friction fitting 124 may be configured to couple to the lower tubular section 122 of the walking aid 102 such that when the user holds the friction fitting 124 while rotating the foot 107, the friction fitting 107 may maintain an outer sheath with respect to the support rod 134, allowing the support rod 134 to rotate. The horizontal slide rod 136 may provide rotational coupling between the foot housing 126, spring piston 132, and support rod 134 which allows preload adjustment of the spring by enacting a rotation on the foot housing 126 while allowing for uninhibited axial motion between the foot housing 126 and the horizontal slide rod 136, thereby correctly directing all of the load through the sensors 104. The forces necessary to preload the spring 106 may fall within the anthropometric twisting strength range for typical adults.

A method may include rotating the support rod 134 in the spring assembly 110 by rotating the foot 107 with respect to the spring sheath 114 such that the threaded slide 158 stays oriented with the slide slot 160 (shown in FIGS. 5A and 5B) causing the threaded slide 158 to travel vertically along the threaded section 161 of the support rod 134, the vertical travel along the support rod 134 increasing or decreasing preload force on the spring 106.

The configuration of the smart foot assembly 100 may allow compression loads to be measured by the force sensor of the sensors 104 at different phases of the gait cycle. As the walking aid 102 contacts the floor and body weight begins to be supported by the walking aid 102, the spring piston 132 may push up against the spring 106. When the body weight through the walking aid 102 surpasses the spring 106 preload, the smart foot assembly 100 will start to shorten, further compressing the spring 106. The smart foot assembly 100 will continue to shorten as the load is increased until the intended stop mechanism is contacted. In some embodiments, this may occur when the horizontal slide rod 136 contacts the inner slide slot 142. In other embodiments, the stop may occur when the sensors 104 hit the support rod 134.

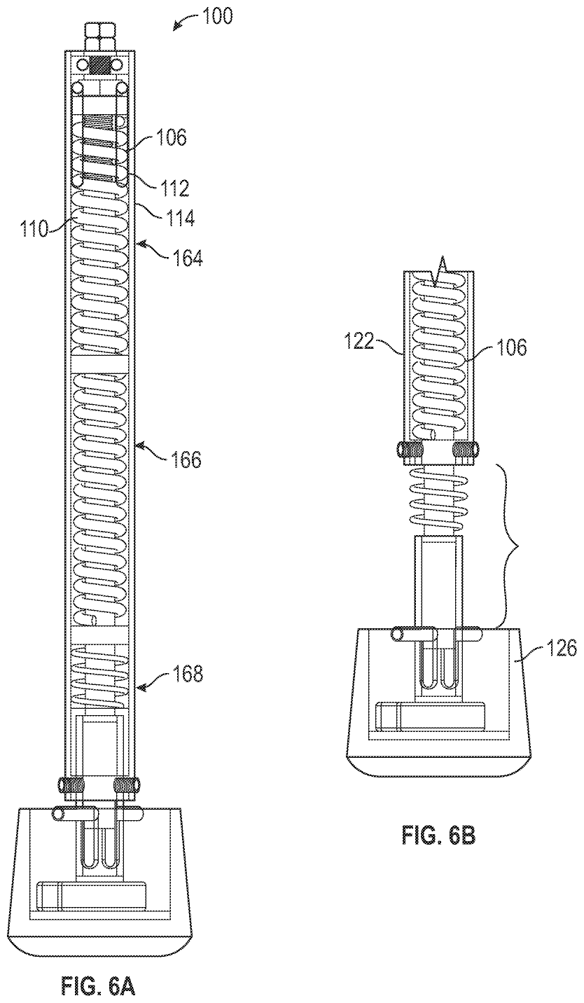

Referring now to FIGS. 6A and 6B, the spring 106 of the smart foot assembly 100 may reside inside the lower tubular section 122 of the walking aid 102 (see FIG. 1B) or within the bore 112 of the spring sheath 114. The spring 106 may be non-linear having sections with different spring rates. The spring 106 may be one integral spring of discrete or continuously changing rates or comprised of multiple linear springs stacked on top of another. An example of the spring sections with differing spring rates is illustrated in FIG. 6A and Table 1. For example, section 164 may have a high spring rate (with Spring 3 (S3)), section 166 may have a medium spring rate (with Spring 2 (S2)), and section 168 may have a low spring rate (with Spring 1 (S1)).

As the spring assembly 110 is preloaded, the lower spring rate section 168 may bottom out and the overall spring rate will become stiffer at higher preloads. This will allow for a compact solution that gives adjustability both at high and low target force values (see Table 2). A linear spring 106 may be used but may require more vertical length and more length of deflection to achieve high force settings, or else it may be difficult to achieve low force settings. The travel of the smart foot assembly 100 may be limited in order to promote user stability but should be enough to allow sufficient reaction time when the user feels the start of compression. The foot 107 may travel between 0.1 and 1.1 inches, or preferably between 0.4 and 0.8 inches. In some embodiments, travel of the smart foot assembly 100 may be 0.5 inch as shown in FIG. 6B.

TABLE 1

| | Spring Rate, K (lbf/in) | Solid Height (in) |
|---|---|---|
| Spring1 (S1) | 20.5 | 0.17 |
| Spring2 (S2) | 177.2 | 1.90 |
| Spring3 (S3) | 285.1 | 1.75 |

TABLE 2

| | Preload | Foot | Total | Overall | Total Force |
|---|---|---|---|---|---|
| | Deflection | Deflection | Deflection | spring rate, | thru Device |
| | (in) | (in) | (in) | Keq (lbf/in) | (lbf) |
| | 0 | 0 | 0 | 17.2 | 0.0 |
| | 0 | 0.1 | 0.1 | 17.2 | 1.7 |
| | 0 | 0.2 | 0.2 | 17.2 | 3.4 |
| | 0 | 0.3 | 0.3 | 17.2 | 5.2 |
| | 0 | 0.4 | 0.4 | 17.2 | 6.9 |
| S1 bottoms out | 0 | 0.5 | 0.5 | 17.2 | 8.6 |
| | 0 | 0.5 | 0.5 | 109.3 | 8.6 |
| | 0.1 | 0.5 | 0.6 | 109.3 | 19.5 |
| | 0.2 | 0.5 | 0.7 | 109.3 | 30.4 |
| | 0.3 | 0.5 | 0.8 | 109.3 | 41.4 |
| | 0.4 | 0.5 | 0.9 | 109.3 | 52.3 |
| | 0.5 | 0.5 | 1.0 | 109.3 | 63.2 |
| | 0.6 | 0.5 | 1.1 | 109.3 | 74.2 |
| | 0.7 | 0.5 | 1.2 | 109.3 | 85.1 |
| S2 bottoms out | 0.7 | 0.5 | 1.2 | 109.3 | 88.8 |
| | 0.8 | 0.5 | 1.3 | 285.1 | 107.7 |
| Maximum | 0.9 | 0.5 | 1.4 | 285.1 | 136.2 |
| deflection | | | | | |

To measure the distance the spring 106 is compressed, a stretch sensor, strain gauge or any distance sensor such as LIDAR, ultrasound, or magnet may be used. Since the spring 106 will have a known spring rate, the distance will directly correlate to the force through the smart foot assembly 100. Alternately, a linearly translating stop plate (not shown) or other geometry to provide a reaction surface for the spring 106 to press against may be moved into position to set the force characteristics of the smart foot assembly 100.

The spring 106 may have a physical stop (not shown) to prevent unwanted shortening of the smart foot assembly 100 (which could cause instability for the user) or it may rely on the spring 106 to become very stiff as it compresses past a specific point Alternately, the smart foot assembly 100 may be designed to keep shortening at a specific force, thereby ignoring stability effects, but increasing the force-limiting nature of the smart foot assembly 100. This may be optimal for young, healthy, or athletic users, who have healthy physical coordination and stability. This may be achieved with a spring 106 having low or negligible spring constants such that its force output remains relatively constant at any length of compression. Extra-long compression springs, gas struts, or compliant linkages are some of the components that may achieve a low spring constant. Compliant linkages may have the advantage of having infinite or near-infinite fatigue life and customizable force characteristics.

The target weight bearing setting may be set by the user, physician, or therapist via manual preloading of the spring 106. During operation, the spring 106 may provide dynamic feedback to the user as the spring 106 starts to compress. At the onset of compression, the user will be able to gauge the force and distance remaining until the target is met (at the stop point shown in FIG. 3B) because that distance always remains constant. Dynamic feedback may be preferable to other feedback methods because it is silent, unobtrusive, and comfortable. In fact, the damping provided by the spring 106 may increase the user's comfort compared to a standard, rigid walking aid 102. The user may aim to have the smart foot assembly 100 compress up to the stop point but not beyond. Any consistent deviation from the target may be signaled to the user by a mobile application with recommendations on how to obtain better performance. The standard user ought to be able to meet the target force within an acceptable range because of the combination of live feedback and reviewed performance via the mobile application.

Additional injured limb overloading may be possible after the set point is reached if the user disregards the dynamic feedback. Therefore, auditory feedback such as an audible overload alarm may be incorporated at a set ‘high-overload’ threshold beyond the target set point. An alarm may be configured to provide auditory feedback when the force sensor reaches a predetermined level. The high overload alarm may be set automatically based on the target weight setting or may be adjusted to a customized level. When the force sensor of the sensors 104 (see FIG. 2) reaches the high overload level, it may communicate this to the user's mobile device 170 (see FIG. 20A) via Bluetooth and cause the mobile device 170 to emit an auditory alarm. Alarm sound characteristics may also be customized per user. In other embodiments, an audible alarm and speaker may be coupled to the microprocessor 128 (see FIG. 2) and located in the smart foot assembly 100.

In addition to the high overload alarm, the dynamic feedback of the spring 106 (see FIG. 6A) may be supplemented by a mechanism that provides both a ‘low-acceptable force’ feedback and a ‘high-acceptable force’ feedback. An example mechanism is shown in FIG. 8. The mechanism may be a feedback mechanism. With this mechanism, the smart foot assembly 100 may compress as previously described; however, prior to hitting the stop point 172, the horizontal slide rod 136 may react against gate arms 174 located proximal to the stop point 172. The inner slide slot may have the feedback mechanism located proximal to the upper end of the inner slide slot for providing feedback as the horizontal slide rod 136 is arrested by the feedback mechanism. The gate arms 174 may provide a known resistance force against the horizontal slide rod 136 moving up to the stop point 172. This resistance may be achieved by torsion springs, a compliant hinge, or other spring-type mechanism. Compliant hinges 176 are shown in FIG. 8 by example. Thus, the user may feel the ‘low-acceptable force’ feedback at the point that the horizontal slide rod 136 is arrested by the gate arms 174 and may feel the ‘high-acceptable force’ feedback when the horizontal slide rod 136 travels past the gate arms 174 to the stop point 172. The spring mechanism of the gate arms 174 may be such that it provides resistance of small magnitude to the horizontal slide rod 136 as it travels back downwards from the stop point 172.

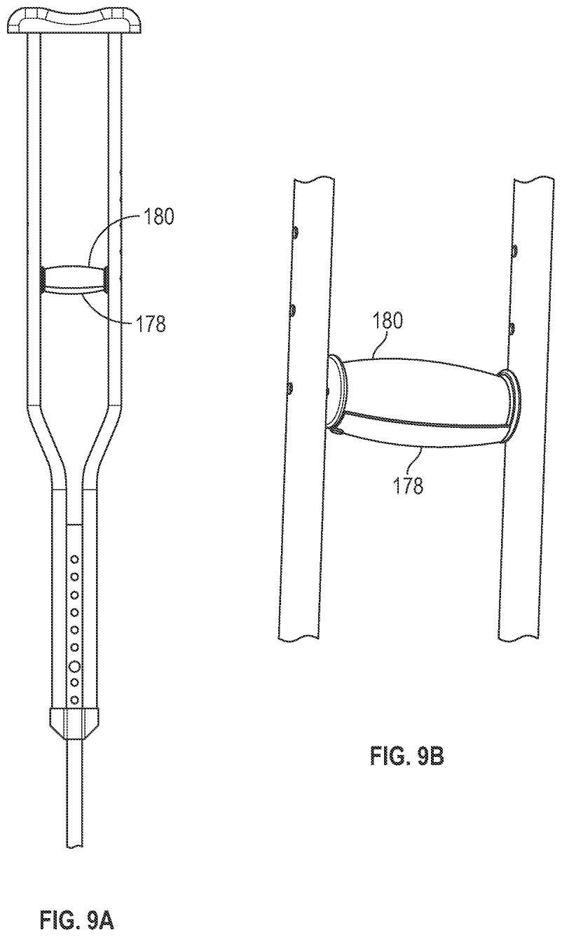

Referring now to FIGS. 9A and 9B, the smart foot assembly 100 may also have a vibration module 178 in a handle 180 that activates when the force sensor of the sensors 104 (see FIG. 2) reaches a predetermined level. Characteristics such as intensity or frequency may be varied to provide differentiated feedback signals for different thresholds/alarms. The vibration module 178 may include a piezoelectric buzzer surrounded by ergonomic material which is wired or wirelessly connected to either the electronics in the foot housing 126 (see FIG. 2) or to the mobile device 170 (see FIG. 20A). Other tactile mechanisms include a button or switch (not shown) that moves locations to indicate whether the user is in the acceptable range.

Other embodiments include visual feedback including light-based displays such as LEDs, where the status of support forces may be indicted by color, intensity, flashing, or number of lighted elements. The lights or indicators may be located on the body of the walking aid 102 (see FIG. 1B) or on a headwear (not shown). For the headwear, peripheral lights in the line of sight of the user may be wirelessly connected via Bluetooth.

The force data measured by the force sensor of the sensors 104 (see FIG. 2) may be sent via Bluetooth connection to a nearby mobile device 170 (see FIG. 20A). The data will then be processed in a mobile application and displayed in useful format to the user. This may include options for real-time charts showing approximated loads through the injured leg compared to targets. Since oftentimes the user may not be checking the data real-time, the most important communication may be the historical gathered data. Timeframe adjustable summaries may be available to provide a user-friendly view of user weight bearing compliance. Longer term data summaries may be used with additional gait data, user-input pain metrics, and/or physician evaluations to show progress over time. Data incorporated into the summaries may include the following: load through walking; approximated load through injury; step counts; step frequency (speed); duration of exercise; balance/consistency; user-entered pain metrics; user-entered exercises/stretches; and physician evaluation metrics. Measurements obtained from the force sensor may be provided for display on the electronic device such as a mobile device.

To approximate the load through the injury to a high degree of accuracy, the mobile application may use data from integral mobile IMU measurements. Since the device will often be located on the user (pocket, wrist, or other location), gait phase events such as a heel strike and a toe off can be detected and used to better approximate gait loading. Data from sensors located in proximity to the user's foot or the distal end 109 of the foot 107 may be incorporated into the gait phase event data. In the absence of IMU data, the mobile application may still use the force sensor data to approximate the injury loading based on known patterns. Cues and patterns from the force data may be used to deduce gait events such as double stance time, heel strike, and toe off. In embodiments, at least one sensor for gathering gait phase event data and measured device force in the foot 107, the spring sheath 114, or in proximity to the user's foot may be utilized. The gait phase event data and measured device force may be taken and transited into an estimated force through the user's leg.

In embodiments, one or more accelerometers, gyroscopes, magnetometers, or inertial measurement units may be included in the foot housing 126 (see FIG. 2). Data from such sensors located in proximity to the user's foot may be utilized. These devices may measure the acceleration and orientation of the device. The data may then be sent to the mobile device 170 (see FIG. 20A) and analyzed to provide one or more of the following: more accurate gait detection; fall prediction; fall detection; emergency alarm; and tottering or tremors. In embodiments, inertial measurement unit data from the mobile device may be incorporated into the data including gait phase event data, fall prediction, or fall detection.

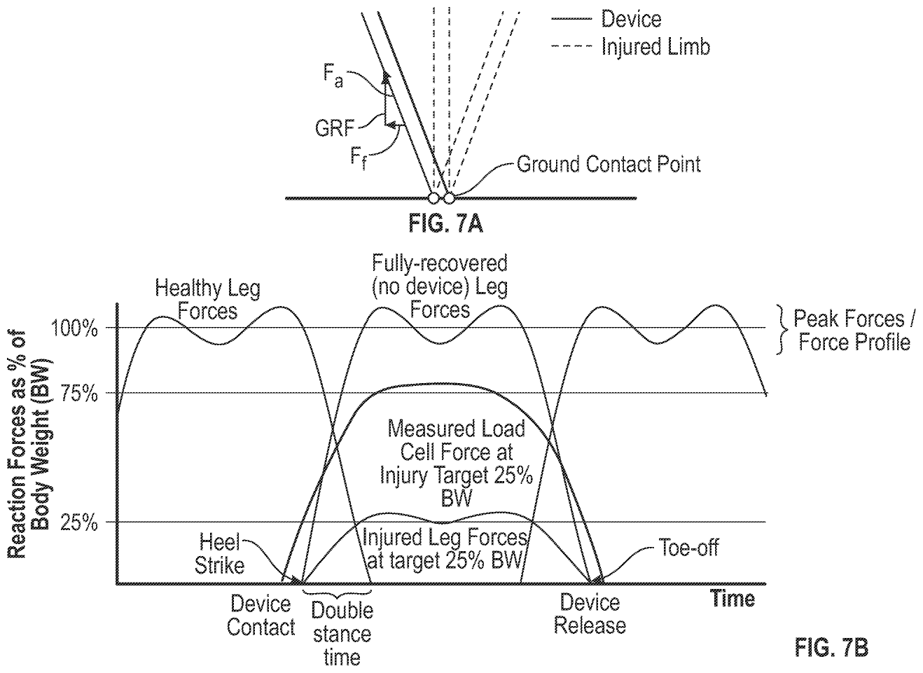

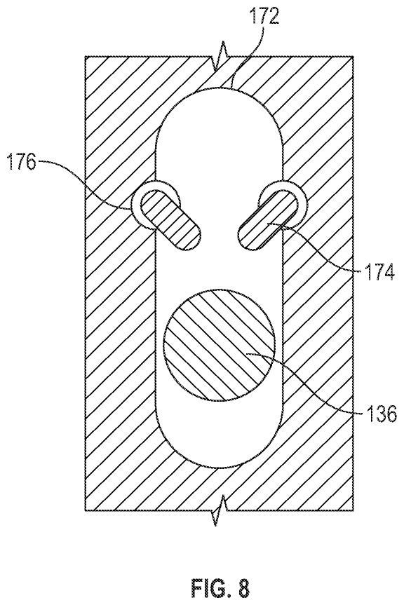

Additionally, the user may calibrate the mobile application to their individual gait during first setup. This may include the user capturing video of the user walking with the smart foot assembly 100 by filming on their mobile device 170 (see FIG. 20A). Gait events such as a toe-off and a heel-strike may be automatically recognized in the video by the mobile application or may be flagged by the user. The mobile application may use this data to determine user-specific gait characteristics such as double stance time, which may then inform the estimation of forces through the injured leg in later use of the smart foot assembly 100 and the mobile application. An example of methods the application can use to take the data acquired and estimate the injured limb forces and other useful information is shown in FIGS. 7A and 7B and Table 3.

TABLE 3

| | Source | Data | Output | Method |
|---|---|---|---|---|
| Base | User | Body weight | Healthy/Fully- | User-input into app |
| | variables | and height | recovered leg | |
| | | | forces | |
| | Population | Gait | Leg axial forces as | Estimated gait |
| | studies | characteristics: | function of GRF | profile is determined |
| | | GRF profiles | forces | based on user height |
| | | and stride | | and weight. Axial |
| | | angles | | forces may be |
| | | | | calculated with stride |
| | | | | angle and vertical |
| | | | | GRF. |
| | Load cell | Axial force thru | Axial force thru | Injured leg axial |
| | | device | injured leg | force = Fully- |
| | | | | recovered leg forces |
| | | | | minus Device force |
| Supplemental | App | Device contact | Enhanced | Calibration will |
| | Calibration | and release vs | accuracy of | record the delay |
| | and/or | heel strike and | injured leg force | between device |
| | mobile | toe off | estimates | ground contact and |
| | IMU data | | | injured leg contact. |
| | | | | Any forces on the |
| | | | | device when the |
| | | | | injured leg is not in |
| | | | | contact will be |
| | | | | attributed to a |
| | | | | reduction in healthy |
| | | | | leg axial force. |
| | App | Double stance | Enhanced | Estimate gait profile |
| | Calibration | time as function | accuracy of | based on user height |
| | and/or | of step | estimated gait | and weight will be |
| | mobile | frequency | profile | updated according to |
| | IMU data | | | actual collected data. |
| | Foot | Foot contact | Enhanced | Gait event and foot |
| | sensors | events | accuracy of | location data will be |
| | | | injured leg force | sent to app and used |
| | | | estimates. | in additional |
| | | | Additional gait | algorithms and |
| | | | stability and | communications. |
| | | | characterization | |
| | | | data. | |

In order to estimate injured limb forces, the user may input their body weight and height into the mobile application. Statistical use of previous gait studies may provide an estimate of healthy gait cycle loading for a particular height and weight. This may include the vertical ground reaction forces during a single leg stance which peak at approximately 110% of body weight at the beginning and end of the single leg stance and fluctuate to approximately 90% of body weight in the middle of the single leg stance. It may also provide the statistically most likely force profile during the double leg stance phases, which in some cases may be approximated by a linear increase in the onloading leg and a linear decrease in the offloading leg.

Statistics may also be used to approximate stride length based on user input characteristics. Stride length and gait characteristics may be used to estimate healthy leg axial loads based on trigonometry. This ‘healthy leg axial force profile’ may be used along with the measured data to estimate the ‘injured leg axial force profile.’

The force sensor of the sensors 104 (see FIG. 2) measures the axial forces through the walking aid 102 (see FIG. 1B). This data may then be used to determine the injured leg forces. The injured leg axial force profile may equal the healthy leg axial force profile subtracted by the measured axial force. This equation assumes that the walking aid 102 (see FIG. 1B) is supporting weight at a similar angle to the leg (see FIG. 7A). Vertical Ground Reaction Forces (“GRFs”) may be related to axial force, Fₐ, and friction force, F_{f}, as shown in FIG. 7A. Cues and patterns from the force data may also be used to deduce gait events such as double stance time, heel strike, and toe off, thereby improving the accuracy of the approximations.

Additional information may make the estimated injured leg forces more accurate. As detailed above, the user may calibrate the mobile application to their individual gait during initial setup. This may include the user capturing video of themself walking with the smart foot assembly 100 by filming gait events on their mobile device 170 (see FIG. 20A). The mobile application may use this data to determine user-specific gait characteristics which then informs the estimation of forces through the injured leg in later use of the smart foot assembly 100 and mobile application. The calibration may include walking at different speeds.

Additional sensors 104 (see FIG. 2) may be used to more precisely determine gait characteristics and foot contact events. These sensors 104 may be force sensors, proximity sensors, or may use visual or audio cues to determine heel strike, toe-off, device contact, or other events. The sensors 104 may be located in proximity to the user's foot such as under the user's foot (for example, as a force sensing insole) or on the non-slip surface 108 (see FIG. 1B) of the walking aid 102 (see FIG. 1B) device (for example, as a line of sight sensor or a microphone to pick up footfall events) and automatically couple via Bluetooth with an electronic device.

Options for such sensors 104 include: thin-film pressure-sensing insoles worn inside socks or shoes, distance or proximity sensors located on the lower section of the walking device able to detect foot location, using such technologies as: LIDAR or laser time of flight, ultrasound, magnetic Hall Effect, camera with video processing, microphones located on walking aid 102 to detect foot contact events, or a simple compression detector (contact sensor) on foot to give a binary contact/no-contact reading. These additional sensors may provide the following data: improved load through injury approximations; stride length, width, or balance; ground speed; foot angles and posture.

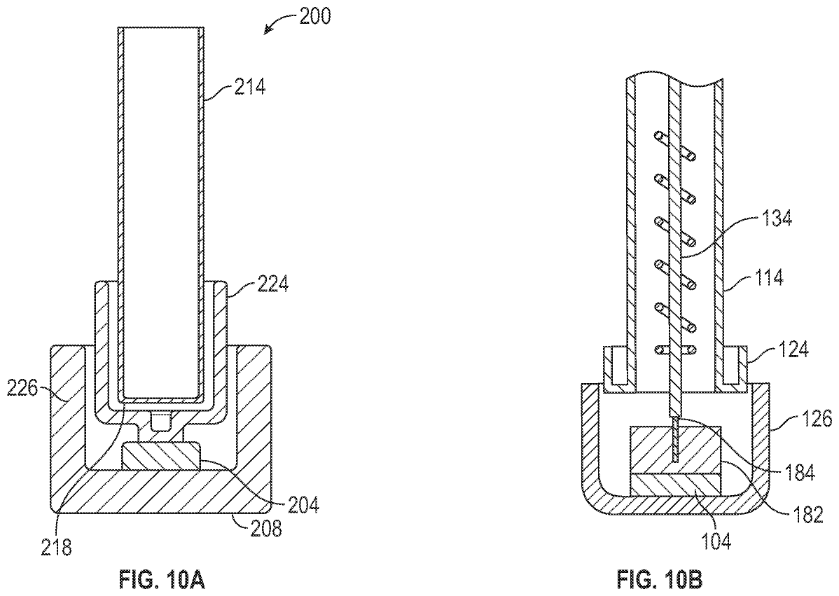

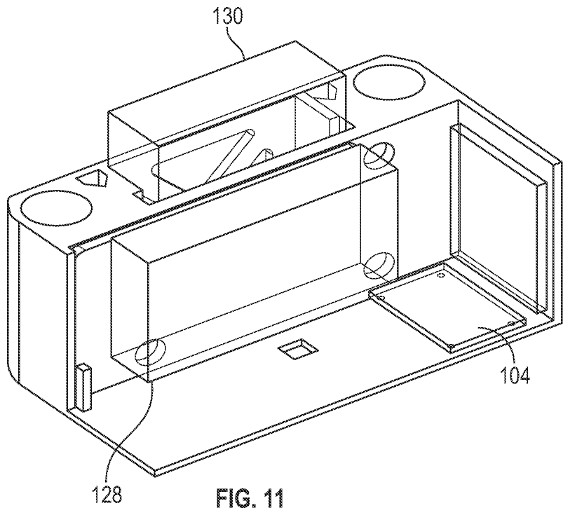

Referring now to FIG. 10A, it is further envisioned that the above data may be gathered with a smart foot assembly 200 that does not have the spring assembly 110 (see FIG. 1C). The smart foot assembly 200 would be comprised of a friction fitting 224 and a foot housing 226 coupled to a distal end 218 of a tubular sheath 214 having a non-slip surface 208 at the bottom of the foot housing 226 for engaging a ground surface. Sensors 204 including a force sensor may be coupled to the friction fitting 224 such that during the load phase, as the non-slip surface 208 contacts a ground surface, forces may be directed through the force sensor and force data sent via Bluetooth for communication to the user as mentioned in other embodiments.

While force sensor calibration may be done at the factory, an option for recalibration may be available to the user via the mobile application. Directions for the recalibration may be described and illustrated on the mobile application.

Referring now to FIG. 10B, some embodiments may include a motor 182 for automatically adjusting the spring 106 preload. The motor 182 may be located inside the spring sheath 114, mounted to the outside of the spring sheath 114 or attached to the foot housing 126 as shown in FIG. 10B. The motor 182 may be coupled to the support rod 134. When the motor 182 is powered, it may rotate the support rod 134 with respect to the walking aid 102 (see FIG. 1B), friction fitting 124, and spring sheath 114, which in turn may cause the threaded slide 158 (see FIG. 5A) to translate linearly and thus the spring pre-load to be adjusted. The motor 182 may be a stepper motor or a servo motor. A shaft 184 of the motor 182 may be aligned axially with the smart foot assembly 100 or may be offset axially and connected via a gear train. When adjusting, one may input a target force into the mobile application, which may then send a signal to the microprocessor 128 (see FIG. 2), to turn on the motor 182 until a desired pre-load force is established. The motor 182 may turn off when the correct pre-load force is measured through the force sensor of the sensors 104.

In another preferred embodiment, the smart foot assembly 100 may include the following components: hardware used for measuring weight exerted on a walking aid (see FIG. 1B) and for providing effective biofeedback, means for calculating the force being exerted in the patient's injured limb, and an interface, for example mobile phone application, used for informing the user and physician of the patient's progress under partial weight bearing therapy.

Referring now to FIG. 11, the hardware may consist of a Raspberry Pi 3B+ microprocessor 128, a force resistive sensor (e.g., Sensiforce) of the sensors 104, an IMU orientation sensor (e.g., Berry IMU) of the sensors 104, and two vibration motors (not shown) used to provide biofeedback. The microprocessor may record and analyze the measurements obtained from the force sensor and the orientation sensor of the sensors 104. With this data, it may provide the biofeedback mechanism needed for patients to correctly perform their partial weight bearing therapy. The force sensor may be placed at the end of the smart foot assembly 100 in order to record the force being exerted on the walking aid 102 (see FIG. 1B). The orientation sensor may measure the x and y angles of the walking aid 102 with respect to the ground surface, and the swing of the patient may be measured with the orientation sensor's recording in the y direction angle.

The microprocessor 128 and subsequent sensors 104 may utilize a Python-based script that collects the force and orientation measurement. While the microprocessor reads the force sensor and IMU measurements, it may calculate the ground reaction force at the non-slip surface 108 (see FIG. 1B), extrapolate the ground reaction force through the injured leg and write the data to .csv files. From this data, gait cycles may be identified and analyzed to determine whether the force through the injured leg met the weight bearing requirement.

The microprocessor 128 may calculate the force being exerted on the injured limb of a patient by first calculating the maximum ground reaction force of the walking aid 102 from the force being exerted on the walking aid 102 and its x and y angles with respect to ground during the midstance phase of the gait cycle of a patient. Then, it may calculate the force being exerted on the limb of the patient based on this information and the novel equation below. Once the microprocessor 128 obtains this information, it may provide the appropriate biofeedback to the patient via a vibration motor (not shown) located on each smart foot assembly 100.

The information recorded while using the smart foot assembly 100 may be transferred via Bluetooth to a mobile application that is capable of displaying several aspects of the gait cycle of the patient including force on the walking device, force on the limb, and amount of biofeedback required. This allows the patient and physician to evaluate patient's progress and provides useful insight to improve the partial weight bearing therapy. The hardware may provide patient biofeedback during the partial weight bearing process via two vibration motors (not shown). The force being exerted in the injured limb of the patient may be calculated in order to ensure the accuracy of the biofeedback.

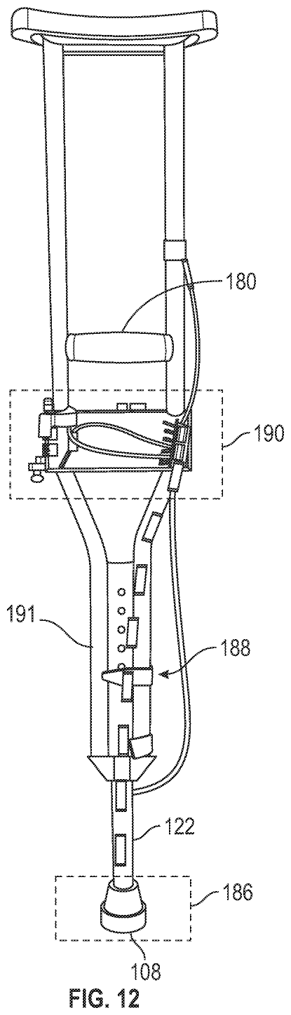

Referring now to FIG. 12, force may be measured at non-slip surface 108 via a rubber sensor-integrated tip 186 of the foot housing 126. The tip 186 may have the force sensor. The sensor or sensors 104 at the tip may be connected via wires 188 to the Raspberry Pi 3B+, which may be housed under the walking aid handle or hand grip 180. A standard crutch may be used as the walking aid 102 and the wires 188 may be routed through the crutch, from the crutch tip 186 to a hardware housing 190. To allow this connection to be made, a small hole may be drilled into one side of the crutch under the handle. A shaft 191 may connect the hand grip 180 and the tip 186.

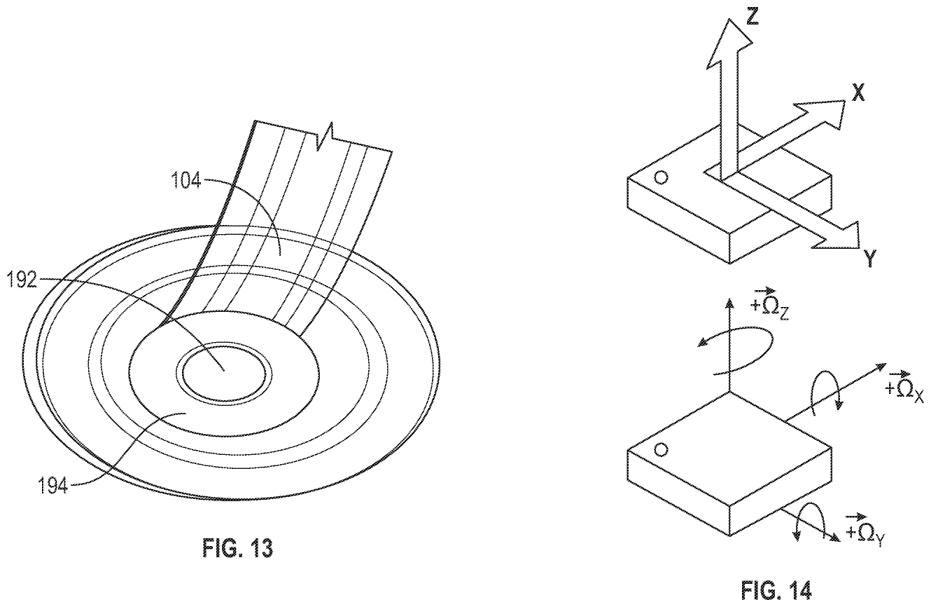

Referring now to FIG. 13, the force sensor of the sensors 104 may be a thin film resistive sensor such as the TekScan FlexiForce Pressure Sensor. The sensing area may be a thin circular piece with a 0.375 in. diameter, located at one end of the sensor. This piece may be connected to a 7.5 inch strip with male pins at the other end. The circular area of the force sensor may be placed at the crutch tip 186 (see FIG. 12). Most crutch tips are rubber to allow for grip and shock absorbance during use, and slide onto the lower tubular section 122 (see FIG. 12). As a result, to provide a hard and flat surface for the force sensor, a circular piece of wood 192 may be securely placed inside the bottom of the crutch tip 186. The force sensor may be sandwiched with another smaller circular proximal piece of wood (not shown) with the same diameter as the force sensor. This may allow for proper force distribution across the entirety of the sensor surface. The wood piece 192 may be secured by a ring of acrylic 194 to ensure it does not shift as the user walks. The rest of the force sensor strip may be placed into the lower tubular section 122, where the pins may be connected to the wires 188 that may be routed to the microprocessor 128.

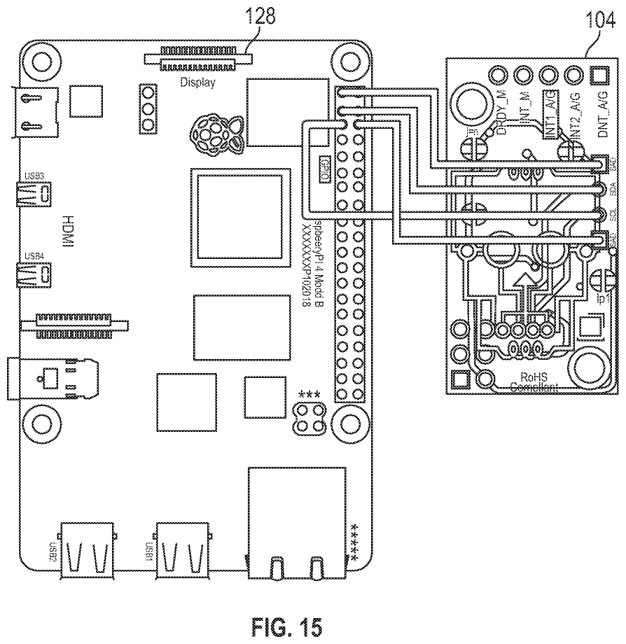

The orientation sensor of the sensors 104 may be a Berry IMU that consists of a combination of a 3.3-5V 3-axis gyroscope, 3-axis accelerometer, 3-axis magnetometer with a microprocessor 128 (see FIG. 15) that allows ±45° in the x and y directions with respect to the ground as shown in FIG. 14. The IMU may communicate via the I2C interface of the Raspberry Pi microprocessor 128 as shown in FIG. 15. The orientation sensor may be connected to the Raspberry Pi ports of Ground, SDA, SCL and 3.3 V (Ports 6, 2, 3, and 1 respectively). The orientation sensor may be located inside the smart foot assembly 100 or the walking aid 102 to be closer to the center of mass of the crutch than the crutch tip 186. As a result, having the orientation sensor in the casing minimizes errors when measuring the orientation of the whole crutch. The interface may be coupled to the microcontroller or microprocessor for informing a user of the smart walking device (e.g., using a smart foot assembly) of the measurements obtained from the force sensor and the orientation sensor.

The software used to power the orientation sensor may be obtained from the Berry IMU library. A software-based complementary filter may be used to overcome any inherent gyro drift and accelerometer noise of the orientation sensor. The filter may allow use of the gyro measurements to determine the value of rapidly changing angles and the accelerometer measurements for long-term stable angle recordings. This may be achieved by using the following equation:

Current angle=AA×(current angle+gyro rotation rate)+(1−AA)*(Accelerometer angle)

where AA is the complementary filter constant determined by AA=t/(t+dt), t is the time constant of the filter that will be determined upon the best configuration based on the gait cycle of the patient. The best filter constant AA may be approximately 0.9 given the approximate time of the gait cycle of a patient, but it is envisioned that AA may be in the range of 0.85 to 0.95.

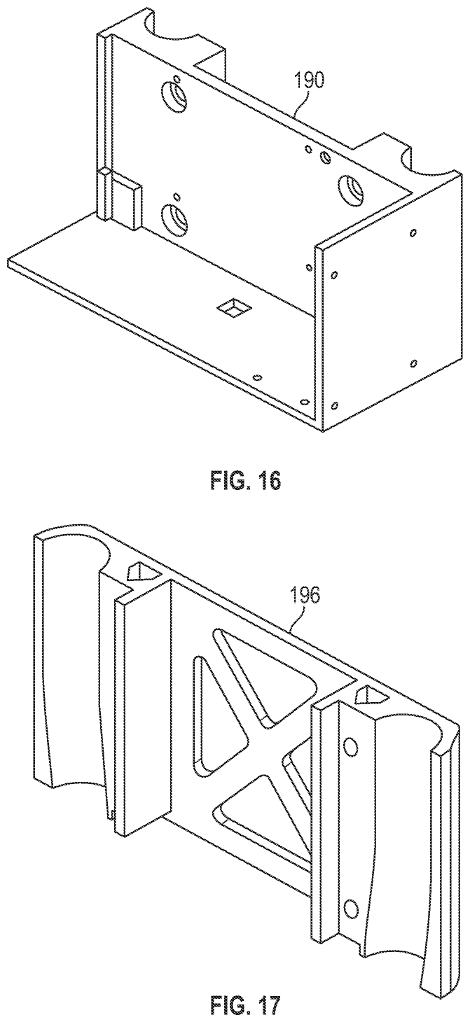

Referring now to FIG. 16, the electronics of the device may be located inside the hardware housing 190. The housing 190 may be attached to the side of the crutch underneath the walking aid handle or hand grip 180 (see FIG. 12) using screws. The housing 190 may be located in proximity to the hand grip 180. The hardware housing 190 may be attached by screwing a mount 196 shown in FIG. 17 that may surround the two bars of the crutch. The drawings in FIGS. 16 and 17 may be 1:2 scale in inches. Inside the housing, the microcontroller or microprocessor 128 (Raspberry Pi 3B+) (see FIG. 11) may be placed vertical to the ground and fixed with screws into holes on the side of the hardware housing 190 to minimize housing extrusion outside of the crutch. The orientation sensor may be screwed flat on the bottom part of the case, parallel to the ground to make sure the influence of z-axis angle is minimized. The microcontroller or microprocessor 128 may be configured to record and analyze measurements obtained from the force sensor and the orientation sensor. The biofeedback and force measurement circuits may be placed on a perforated board, which may be secured vertical to another side of the casing. A button switch (not shown) may be fixed outside the wall of the housing to allow control of starting/stopping the measurement script. An indicating light (not shown) may also be fixed on the wall. The battery 130 (10000 mAh−2 ports×5V, dimension 3.6″×″2.5×0.9″) (see FIG. 11) may be housed in the space between two bars on the crutch to allow powering of the microprocessor 128. Two wires 188 (see FIG. 12) may extend from the microprocessor 128 inside the casing out through the hole at the bottom to connect to the force sensor inside the crutch tip 186.

Bluetooth may be used to communicate between the microprocessor 128 (see FIG. 11) and a mobile device 170 (see FIG. 20A). A command lined script in the microprocessor 128 may send newly recorded measurements from the sensors 104 (see FIGS. 2 and 11) to the mobile device 170. The Bluetooth may always be turned on in the microprocessor 128, but file transfer may only initiate when a signal is received from the mobile device 170 to synchronize data. The mobile device 170 may use Bluetooth to receive the recorded measurement for data display in the mobile application, and it may also send updates of patient weight and weight bearing limitations prescribed by the physician to the microprocessor 128. Updates may be automatically integrated into the measurement and feedback scripts to adjust the weight bearing limit and provide more accurate biofeedback.

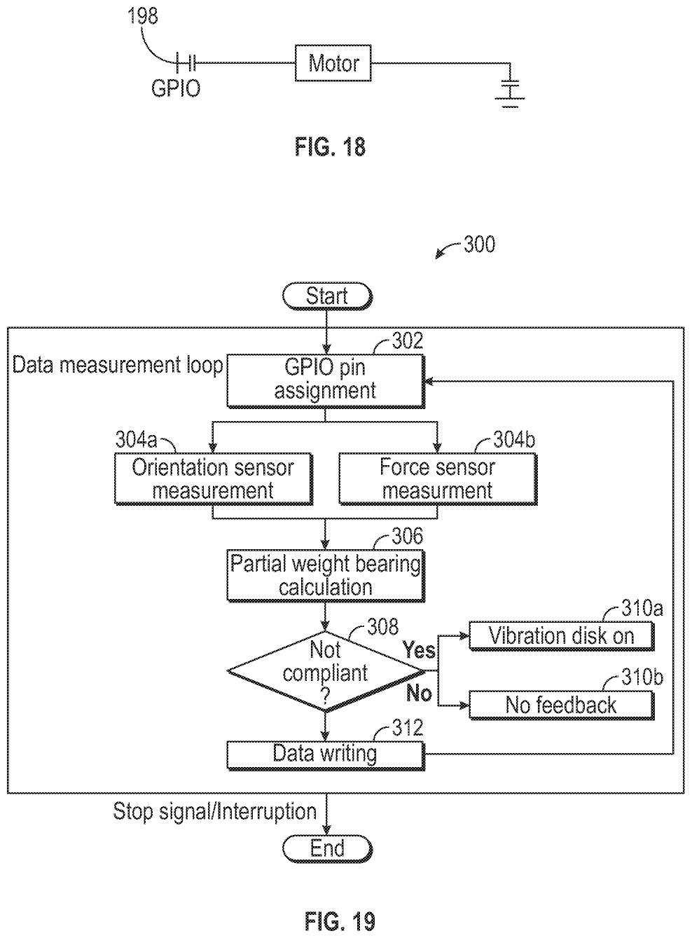

To alert a patient when they are putting too much or too little weight through the injured limb, a tactile biofeedback may be incorporated on the instrumented crutch. A mini vibrating disk (10 mm diameter, 2.7 mm thick) may be powered from the microprocessor 128 (see FIG. 11) through a GPIO out pin 198 (see FIG. 18) and placed on the handle 180 (see FIG. 12). If the weight the patient puts through the injured leg is higher than the preset threshold, the vibrating disk may make a long and strong vibration. If the weight applied through the injured limb is lower than the lower limit of weight bearing, the vibrating disk may make short vibrations. Patients are expected to adjust their weight bearing so that no biofeedback is produced. The complete workflow of biofeedback generation is shown in FIG. 19.

Referring now to FIG. 19, the process 300 may be executed by one or more components of the smart foot assembly 100. The process 300 may begin with block 302. In block 302, the process 300 may include assigning a GPIO out pin 198 (see FIG. 18). In block 304a, the process 300 may include detecting or measuring orientation data via the orientation sensor. In block 304b, the process 300 may include detecting or measuring force data via the force sensor. In block 306, the process 300 may include calculating partial weight bearing based on the orientation data and the force data. In block 308, the process 300 may include determining whether the calculated partial weight bearing is not compliant. If the partial weight bearing is not compliant, the process 300 may continue with block 310a. In block 310a, the process 300 may include turning on a vibration disk. If the partial weight bearing is compliant, the process 300 may continue with block 310b. In block 310b, the process 300 may include producing no feedback. After block 308, the process 300 may continue with block 312. In block 312, the process 300 may include writing data onto a storage medium or memory. The process 300 may then return to block 302. The process 300 may end if interrupted or a stop signal is received.

Referring now to FIGS. 20A-20D, the smart foot assembly 100 may include a software. The software may be a mobile application. The key functions of the mobile application may include informing patients and physicians of daily compliance, tracking long-term progress, and encouraging use via gamification. The mobile application may allow for data transfer to and from the walking aid 102, thus allowing for personalized inputs such as patient weight.

The user-interface of the mobile application may be designed to provide the patient relevant information to adjust their weight bearing to better comply with physician guidelines. The user interface may encourage patient usage by offering goalposts and achievements to celebrate patient progress. The interface may consist of five key pages: Home (see FIG. 20A), Daily Reports (see FIG. 20B), Long-Term Progress (see FIG. 20C), Achievements, and Settings (see FIG. 20D).

The Home page may contain five main pieces of information. The first piece may be the overall daily compliance of the patient. This may be a single percentage value that allows the patient to understand how well they are performing with partial weight bearing therapy. It may also provide a timeline of activity, which may show how much the patient overloaded, underloaded, or properly loaded in a given time frame (e.g., minutes, hours, days). This may allow the patient to correlate the type of non-compliance with specific activities and times to make adjusting easier. The page may also show the amount of activity the patient has engaged in that day. This is important because partial weight-bearing therapy depends on both the amount of weight loaded on the limb and the time spent with the limb loaded. Finally, the patient may see the battery life of the walking device and the current Bluetooth connection status, allowing the patient to quickly troubleshoot the mobile application.

The Daily Reports page may allow the user to see the overall compliance, overall activity, and a timeline of activity of each day of the recovery. This serves as a detailed database of past data. This page may allow the user to see how successful they have been on specific days and choose lifestyle changes and activities that can better assist their recovery.

The Long-Term Progress page may showcase the patient's compliance, average weight-bearing, and daily activity over the entire time of the recovery. These bar graphs provide a method of seeing aggregate trends during the use of the smart foot assembly 100. A graph of long-term compliance allows the patient to see themselves become better at accurately weight-bearing, which may be encouraging. Similarly, average weight-bearing may increase as the patient undergoes physical therapy, and progress bars may encourage compliance.

The Achievements page may give awards to the patient for meeting compliance, activity, and progress goals. These awards may include, for example, 10 straight days of meeting compliance goals, 10 straight days of meeting activity goals, and 50% recovery achieved. This page helps motivate the user to meet weight-bearing goals by gamifying the recovery experience.

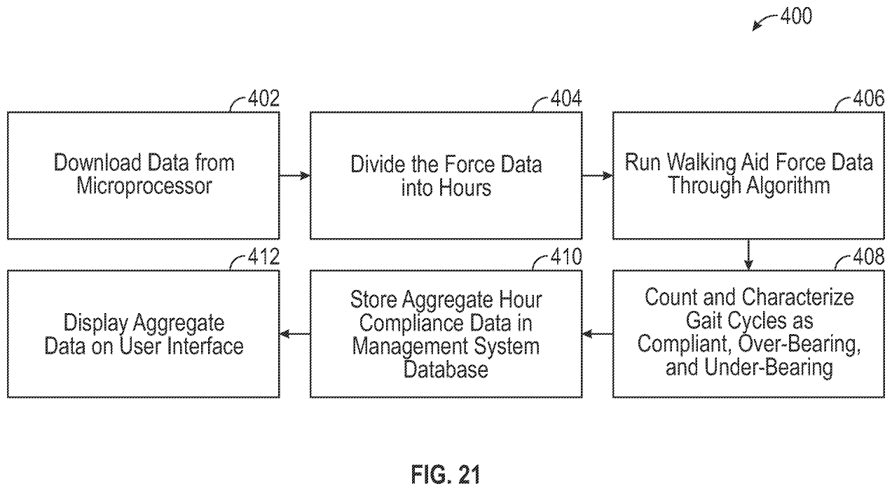

The Settings page may allow the patient to input information about themselves to personalize the device and the application to their specific recovery. This may include physician/physical therapist determined weight-bearing limits, patient weight, and the patient name. To display this information, the mobile application may use back-end data processing strategies to transmit, organize and store the data. This overall process is shown in FIG. 21.

Referring now to FIG. 21, the process 400 may be executed by one or more components of the smart foot assembly 100. The process 400 may begin with block 402. In block 402, the process 400 may include a mobile device 170 (see FIGS. 20A-20D) downloading data from the microprocessor 128 (see FIG. 2). In block 404, a processor of the mobile device 170 may divide the downloaded force data into hours. In block 406, the processor of the mobile device 170 may input the force data into a designated algorithm stored in a local or remote memory accessible by the mobile device 170. In block 408, the process 400 may include counting and characterizing gait cycles as compliant, over-bearing, or under-bearing. In block 410, the process 400 may include storing aggregate hour compliance data of the aggregate data in a database management system (e.g., SQLite Database). In block 412, the process 400 may include displaying aggregate data on a user interface of the mobile application running on the mobile device 170. The process 400 may end with block 412.

Referring back to FIG. 20A, the mobile application may contain a button to sync the mobile application with the microprocessor 128 (see FIG. 2). Upon activation, the script may activate the Bluetooth of the mobile device 170 and connect to the microprocessor 128. Then, the mobile device 170 may download a comma-separated variable file containing force and orientation data from the microprocessor 128. Using the last data point to determine the previous sync time, the script may isolate the new data. The data may be compartmentalized into hourly blocks. Then, the mobile application may use the leg-weight bearing algorithm, which is described in the following section, to convert force data of the walking aid 102 to the force going through the injured leg. Using the zero force data moments when the walking device is in the air, the mobile application may separate the data stream into individual steps. The peak forces in each step may be compared to the force thresholds, and over-bearing under-bearing, and compliant steps may be counted. Dividing these values by the total counted steps produces the percent compliance values. These aggregated percent compliance values may then be stored in a database management system such as an SQLite database for easy recall.

To ensure that the sensors 104 (see FIG. 2) remain accurate, calibration may be performed periodically with automated scripts inside the microprocessor 128 (see FIG. 2). Patients may be prompted for periodical device maintenance through the mobile application.

In partial weight-bearing therapy, patients utilize two walking aids 102 (see FIG. 1B) to locomote. In these cases, it will be necessary to collect data from both walking aids 102. Raw data from the force sensor and orientation sensor of the sensors 104 (see FIG. 2) from both walking aids 102 may be processed by the microprocessor 128 (see FIG. 2).

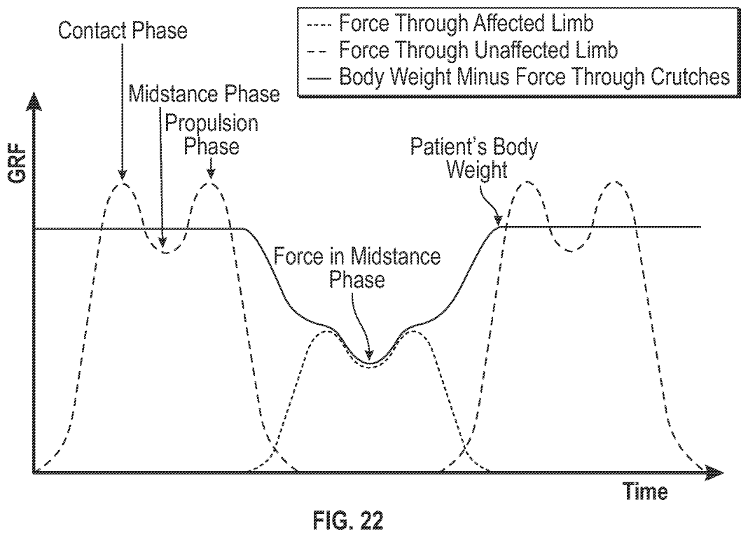

Bipedal animals follow a gait cycle known as an “M curve” due to its shape on a percent body weight (% BW) vs. time graph shown in FIG. 22. During normal walking, this gait cycle has a defined stance phase and swing phase for each leg. Each cycle contains two peaks; the first peak is the heel strike and the second is the propulsion provided by that leg. Midstance is the time period between these two peaks. During midstance, 100% of the person's body weight is on one leg with the other making no contact with the ground. When using two walking aids 102 (see FIG. 1B), known as a 3-point gait, the midstance consists of the injured limb and both walking aids 102 supporting the full weight of the patient and the unaffected leg makes no contact with the ground. For this reason, midstance is the only relevant portion of the gait cycle for the purposes of this disclosure.

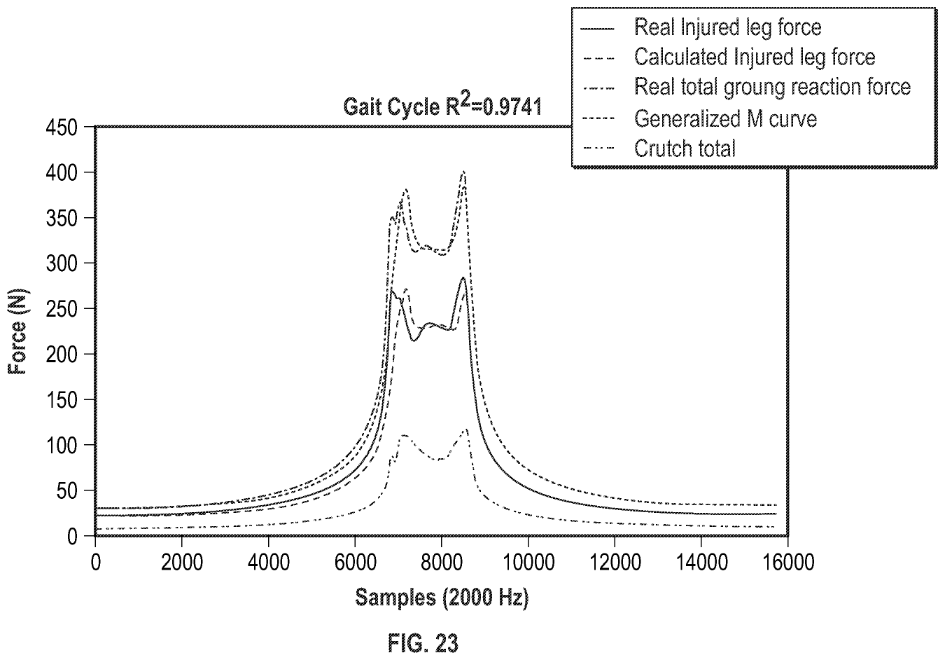

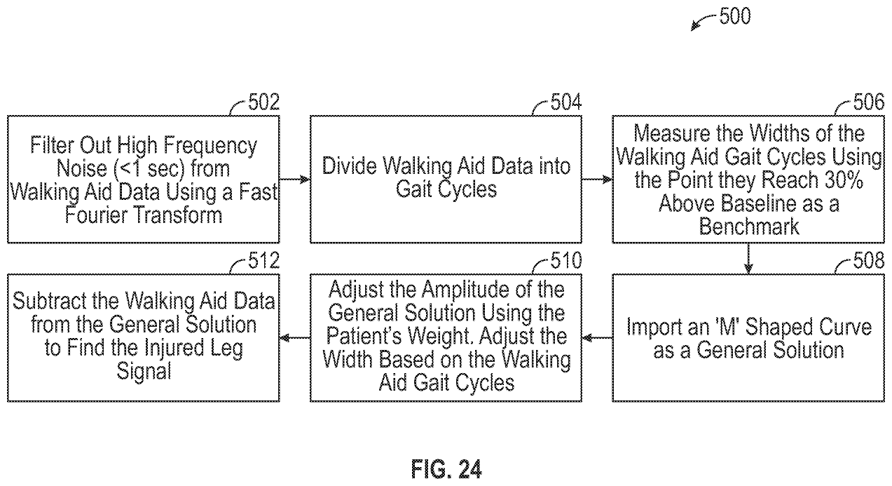

The algorithm may estimate the ground reaction forces on the injured leg using the measured ground reaction forces on the walking aids 102 (see FIG. 1B). This is achieved by assuming a generalized M-shaped curve for the ground reaction forces on the entire body and subtracting the forces measured by the two walking aids 102 therefrom to calculate the force through the injured leg. This is shown in FIG. 23. The M curve's shape is drawn from an empirically measured dataset. The amplitude of the M curve may be determined by setting the center dip of the M curve equal to the user's weight. The M curve's width may be matched to the gait cycle width of the measured force of a walking aid 102. Both of these adjustments may be linearly correlated to their respective parameters. This process may be shown in FIG. 24.

Referring now to FIG. 24, the process 500 may be executed by one or more components of the smart foot assembly 100. The process 500 may begin with block 502. In block 502, the process 500 may include filtering out high frequency noise (i.e., less than 1 second) from walking aid data using a Fast Fourier Transform. In block 504, the process 500 may include diving walking aid data into gait cycles. In block 506, the process 500 may include measuring the widths of the walking aid gait cycles using the point they reach 30% above baseline as a benchmark. In block 508, the process 500 may include importing an M-shaped curve as a general solution. In block 510, the process 500 may include adjusting the amplitude of the general solution using the patient's weight and adjusting the width based on the walking aid gait cycles. In block 512, the process 500 may include subtracting the walking aid data from the general solution to find the injured leg signal. The process 500 may end with block 512.

Variations on these described embodiments will become apparent to those of ordinary skill in the art upon reading the foregoing description. The inventor expects skilled artisans to employ such variations as appropriate, and the inventors intend for the systems, apparatuses, and methods to be practiced otherwise than specifically described herein. Accordingly, the systems, apparatuses, and methods include all modifications and equivalents of the subject matter recited in the claims appended hereto as permitted by applicable law. Moreover, any combination of the above-described embodiments in all possible variations thereof is encompassed by the systems, apparatuses, and methods unless otherwise indicated herein or otherwise clearly contradicted by context.

Groupings of alternative embodiments, elements, or steps of the systems, apparatuses, and methods are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Where used throughout the specification and the claims, “at least one of A or B” includes “A” only, “B” only, or “A and B.” Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A smart foot assembly for providing dynamic feedback to a user, the smart foot assembly comprising:
a spring sheath having a bore with a proximal end and a distal end, the bore holding a support rod having a threaded section that mates with a threaded slide, the threaded slide including at least one protrusion;
a swivel cap coupled to the support rod allowing the support rod to rotate;
a spring assembly housed in the spring sheath, the spring sheath having at least one slide slot that mates with the at least one protrusion of the threaded slide, the spring assembly including a spring coupled to a spring piston;
a foot coupled to the distal end of the spring sheath and having a distal end configured to engage a surface; and
a force sensor coupled to the spring piston and the foot, the spring piston configured to push up against the spring when a preload force is surpassed so that the foot moves proximally as load is increased as the distal end of the foot contacts the surface during a load phase.

2. The smart foot assembly of claim 1, wherein the spring sheath is configured to fit inside a bore of a lower tubular section of a walking aid.

3. The smart foot assembly of claim 2, further comprising a friction fitting configured to couple to the lower tubular section of the walking aid such that when the user holds the friction fitting while rotating the foot, the friction fitting maintains an outer sheath with respect to the support rod, allowing the support rod to rotate.

4. The smart foot assembly of claim 1, further comprising a spring sheath cap coupled to the proximal end of the spring sheath.

5. The smart foot assembly of claim 1, wherein the support rod has a horizontal slide rod located toward a distal end of the support rod and the foot includes an outer slide slot, the horizontal slide rod being slidably engaged with the outer slide slot to allow the user to rotate the support rod upon rotation of the foot.

6. The smart foot assembly of claim 5, wherein the spring is an adjustable spring, and during a no-load phase the preload force in the adjustable spring causes the foot to slide distally until the horizontal slide rod hits an upper end of an inner slide slot.

7. The smart foot assembly of claim 5, wherein, during the load phase, as the distal end of the foot contacts the surface, the foot slides proximally until the horizontal slide rod contacts a lower end of an inner slide slot.

8. The smart foot assembly of claim 5, wherein an inner slide slot has a feedback mechanism located proximal to an upper end of the inner slide slot for providing feedback as the horizontal slide rod is arrested by the feedback mechanism.

9. The smart foot assembly of claim 1, further comprising an inner slide slot in the spring piston, wherein a horizontal slide rod is slidably engaged with both a slide slot in a housing and the inner slide slot.

10. The smart foot assembly of claim 1, wherein the spring is non-linear and has sections with different spring rates.

11. The smart foot assembly of claim 10, wherein the spring is one integral spring.

12. The smart foot assembly of claim 10, wherein the spring includes multiple linear springs stacked on top of another.

13. The smart foot assembly of claim 1, wherein the foot is configured to slide between 0.1 and 1.1 inches.

14. The smart foot assembly of claim 1, further comprising a vibration module in a handle configured to activate when the force sensor reaches a predetermined level.

15. The smart foot assembly of claim 1, further comprising an alarm configured to provide auditory feedback when the force sensor reaches a predetermined level.

16. The smart foot assembly of claim 1, further comprising a microprocessor configured to exchange data via a wired connection to an electronic device.

17. The smart foot assembly of claim 1, wherein the foot includes a housing configured to house a battery, a microprocessor, and a wireless transceiver configured to transfer electronic data to an electronic device.

18. The smart foot assembly of claim 17, wherein the electronic device displays at least one of the following: load through walking, approximated load through injury, step counts, step frequency, duration of exercise, balance/consistency, user-entered pain metrics, user-entered exercises/stretches, or physician evaluation metrics.

19. The smart foot assembly of claim 17, wherein the electronic device displays measurements obtained from the force sensor.

20. The smart foot assembly of claim 17, further comprising a motor coupled to the support rod such that when the user inputs a target force into a mobile application, a signal is sent to the microprocessor to turn on the motor until a desired pre-load force is established.

21. The smart foot assembly of claim 17, wherein inertial measurement unit data from a mobile device is incorporated into data including gait phase event data, fall prediction, or fall detection.

22. The smart foot assembly of claim 21, wherein data from sensors located in proximity to the user's foot or the distal end of the foot are incorporated into the gait phase event data.

23. The smart foot assembly of claim 22, wherein the sensors include at least one of an accelerometer, gyroscope, magnetometer, or an inertial measurement unit.

24. The smart foot assembly of claim 22, wherein the sensors located in proximity to the user's foot include at least one of LIDAR, ultrasound, magnetic hall effect, camera with video processing, or microphones.

25. A smart foot assembly for providing dynamic feedback to a user, the smart foot assembly comprising:
a friction fitting having a proximal end and a distal end, the proximal end configured to couple with a lower tubular section of a walking aid;
a force sensor coupled to the friction fitting and having a distal end; and
a foot coupled to the distal end of the force sensor, the foot configured to engage a surface.

26. A smart walking device comprising:
a tip having a force sensor;
a hand grip having a housing located in proximity to the hand grip, the housing containing an orientation sensor and a microcontroller that is configured to record and analyze measurements obtained from the force sensor and the orientation sensor; and
a shaft connecting the hand grip and the tip.

27. The smart walking device of claim 26, further comprising an interface coupled to the microcontroller for informing a user of the smart walking device of the measurements obtained from the force sensor and the orientation sensor.

28. A method for setting a preload force on a smart foot assembly, the method comprising:
utilizing the smart foot assembly including:
a spring sheath having a bore with a proximal end and a distal end with a spring assembly therein, the spring assembly having a spring coupled to a support rod having a distal end and a threaded section that mates with a threaded slide having at least one protrusion that mates with a slide slot along the proximal end of the spring sheath, and
a foot having a distal end configured to engage a surface and including a housing containing a force sensor coupled to a spring piston concentrically arranged with respect to the distal end of the support rod; and
rotating the support rod in the spring assembly by rotating the foot with respect to the spring sheath such that the threaded slide stays oriented with the slide slot causing the threaded slide to travel vertically along the threaded section of the support rod, the vertical travel along the support rod increasing or decreasing preload force on the spring.

29. A method of providing percentage body weight information to a user of a smart foot assembly, the method comprising:
utilizing the smart foot assembly including:
a spring sheath having a bore with a proximal end and a distal end,
a foot having a non-slip surface at a distal end of the foot for engaging a surface, and
at least one sensor for gathering gait phase event data and measured device force located in the foot, the spring sheath, or in proximity to the user's foot;
taking the gait phase event data and the measured device force; and
translating into an estimated force through the user's leg.

30. A method for providing ground reaction forces on a leg of a user of at least one smart walking device, the method comprising:
utilizing the at least one smart walking device including:
a tip having a force sensor,
a hand grip having a housing located in proximity to the hand grip, the housing containing an orientation sensor and a microcontroller that is configured to record and analyze measurements obtained from the force sensor and the orientation sensor, and
a shaft connecting the hand grip and the tip;
utilizing a generalized M curve for ground reaction forces on an entire body of the user; and
subtracting forces measured by the at least one smart walking device.
